(19) United States
(12) Patent Application Publication
(10) Pub. No.: US 2017/0148070 A1
(43) Pub. Date: May 25, 2017

(54) QSD RATING SYSTEM AND METHOD THEREOF

(71) Applicant: Nour Communication, Riyadh (SA)

(72) Inventor: Allen Hilal Renno, Ad Dammam (SA)

(73) Assignee: Nour Communication, Riyadh (SA)

(21) Appl. No.: 14/946,751

(22) Filed: Nov. 19, 2015

(51) Int. Cl. G06Q 30/02

(52) U.S. Cl. CPC G06Q 30/0282

(57) ABSTRACT

This invention relates to a system comprising a plurality of user device and a platform, wherein the user device and the platform are communicated with each other via the network. An application is located on the user device. The application is configured to prompt the user to enter rating after the user finished a transaction with the merchant which is provided in the application. Users have options to initiate the application automatically or manually while receiving a prompt. The rating data is processed by special algorithms and pushed to the user device automatically or manually. The rating result displayed on the user device has multiple colors labeled and each color corresponds to different satisfaction of the user. Therefore the user will objectively understand this merchant without having to read tons of subjective reviews.

### TECHNICAL FIELD

This disclosure relates to a rating system and a method for operating the rating system.

### BACKGROUND

The Five Star (⋆⋆⋆⋆⋆) rating system is used by the majority of the market. The Five Star rating system is a subjective system especially in the case of Online Food Ordering market. A 5 star, 4 star, 3 star, etc. leaves the user with a vague idea of what it means and what is being measured. The user, to gain a better idea of the rating must read the previous user detail data reviews to gain a better understanding of the rating and what is important to the specific user experience. As a result, especially in the Online Food Ordering business and certain markets/industries where opinions and experiences can play a major role in the outcome of a rating, the subjectivity and inconsistency of rendered services can impact the overall final rating of a business.

### SUMMARY OF THE INVENTION

The object of this invention is to use a rating system and a method for operating the rating system, by which related parameters can be easily and clearly understood.

Another object of this invention is to solve the problem inherited in the Five Star rating system.

The present invention is a Merchants rating system to measure consumer's experience of a merchant after a transaction. There are three service/transaction rating criteria:

Q, S, D: Q=Quality, S=Service, and D=Delivery

The rating criteria can also be:

Q, S, V: Q=Quality, S=Service, and V=Value

Basically, the rating criteria for the merchant is selected from a group consisting of quality, service, delivery, value and environment, and other factors like.

A user that transacts with a Merchant will be asked to rate the merchant based on these 3 criteria.

Each criteria will have 3 rating weights. The user makes the choice based on their experience with the transaction. Options are:
Very Good;
Good/Acceptable; and
Not Good.

Every options will be matched with a different color. Preferably, Green is for Very Good, Orange if Good/Acceptable, and Red is Not Good.

Choices the user made will be aggregated and stored in a database, and Average rating, Bernouli parameter, Posterior probability α Likelihood×Prior probability are some of the formulas being looked at to calculate the aggregate of the ratings once 2+ users rate the same merchant.

The aggregate could result in any one or all of the criteria being Green, Orange or Red, which can create a reflection of overall experience of the consumer around the 3 key service criteria.

At last, the present system will output the rating result to the network which user can easily access to via a plurality of user devices, including: personal computer (e.g., desktop or laptop), tablet computer, mobile device (e.g., personal digital assistant (PDA) or smart phone), server (e.g., blade server or rack server), network storage device, or any other suitable device and may vary in size, shape, performance, functionality, and price.

Hereinafter, this invention will be detail described in conjunction with the figures and embodiments.

### BRIEF DESCRIPTION OF THE DRAWINGS

FIG. 1 shows users rate merchants via the network;

FIG. 2 is a structure schematic diagram of a rating system;

FIG. 3 is a structure schematic diagram of an analyzing unit used in FIG. 2;

FIG. 4 is a flow chart describing the method used in the rating system of FIG. 2.

FIG. 5 is a flow chart describing the method of determining the way to start an application.

FIG. 6 is a flow chart describing the method of determining the way to receive a rating result.

### DETAILED DESCRIPTION OF THE INVENTION

This invention discloses a rating system comprised of user device 200 and platform 300 communicating with user devices 200. User device 200 further comprises displaying unit 210, application program 211, aggregating unit 220, first transmitting-receiving unit 230. Application 211 is stored in user device 200. Displaying unit 210 is capable of displaying the application program so that users can interact with the application program 211. This application program 211 can prompt users to rate a merchant after finishing a transaction with the merchant, and users can start to rate for the merchant according to a guidance in application program 211. Application program 211 then generates an input rating data. Aggregating unit 220 is configured to aggregate the input rating data to generate a rating data. First transmitting-receiving unit 230 is configured to transmit the rating data. Platform 300 comprises: second transmitting-receiving unit 310, analyzing unit 330, and database 320. Second transmitting-receiving unit 310 is configured to receive rating data transmitted by user device 200, analyzing unit 330 is configured to process rating data in order to obtain a plurality of calculated results and then match the calculated results with corresponding colors to generate a rating result, and database 320 is configured to store the rating data and the rating result. Application program 211 can access the rating data and rating results if the rated merchant is authorized to access application program 211. The rating result is displayed by application program 211 when user device 200 communicates with platform 300 via network 100. The rating data and the rating result are updatable in real time, which means the rating result displayed in application 211 is variable according to the aggregated rating data. When user selects to do so, the updated rating result can be pushed to user device 200 in real time. Users can choose to follow certain merchants in application program 211 if they want to, and application program 211 will push a notification that includes the updated rating results of the followed merchant. This information is displayed by displaying unit 210. If the user sets application program 211 such that the user wants to receive real time updates, platform 300 will send an updated rating for a particular merchant to displaying unit 210. The user will get a prompt on displaying unit 210 stating that a new rating data is available in platform 300. After the prompt the user selects the proper application program on user device 200 which starts application program 211 to receive the new rating results from platform 300 via network 100 and first transmitting receiving unit 230. Displaying unit 210 displays the new rating data on user device 200. This way when user is alerted, user will start the application (or application can start automatically depending upon what user selects in setting) and display the result of updated rating for the merchant. Users can also select “no notification” in setting if they wish to do so.

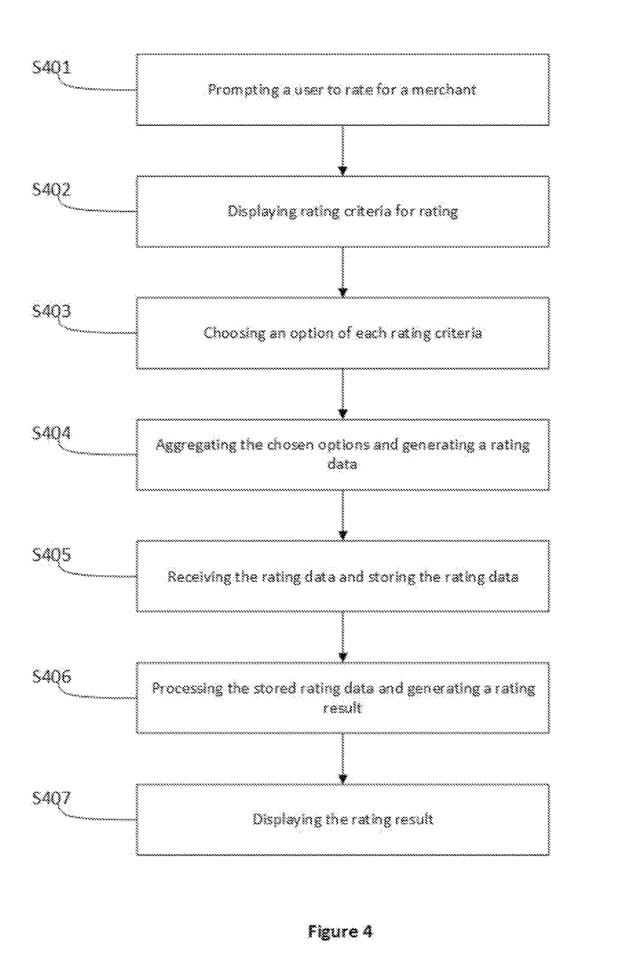

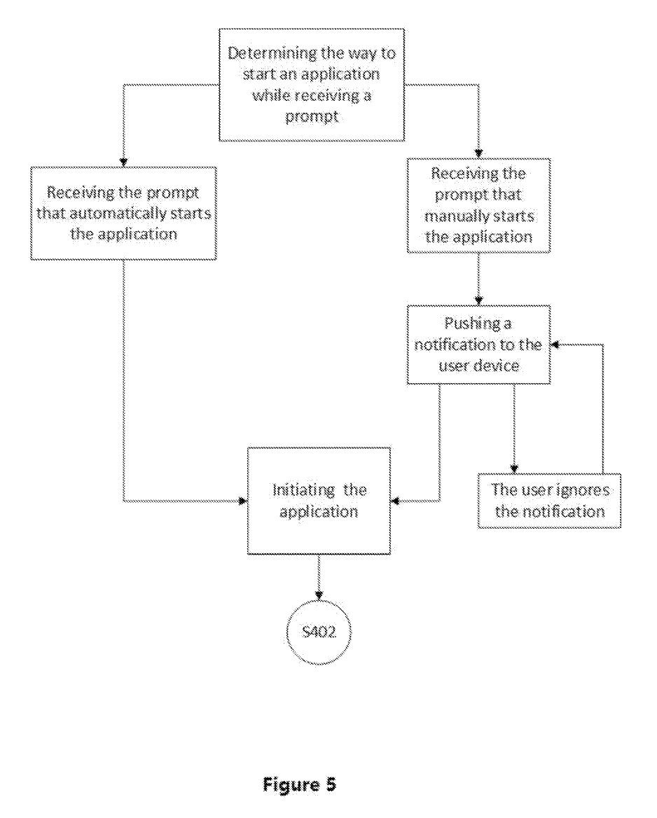

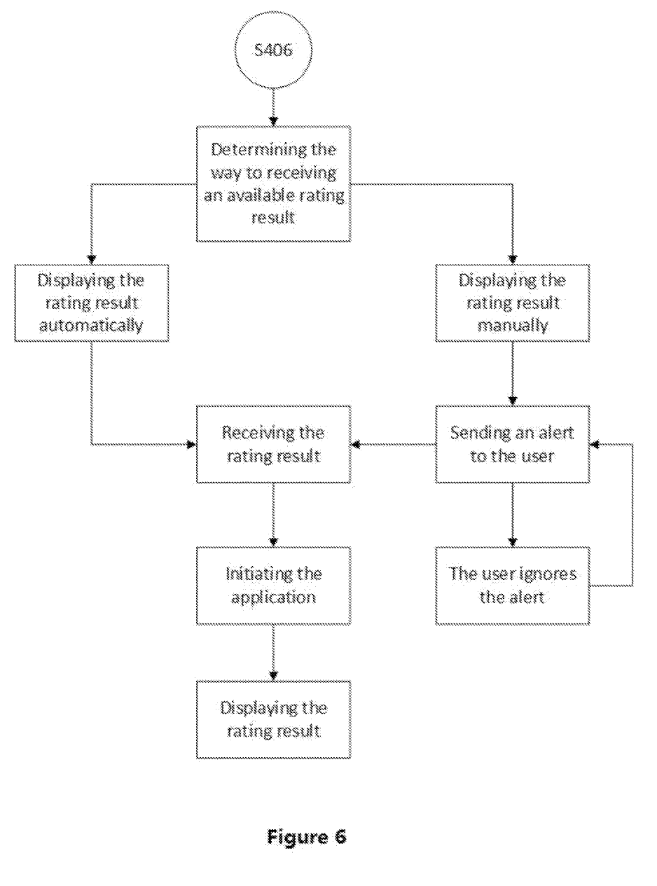

Referring to FIG. 4, FIG. 5 and FIG. 6, the method of collecting, storing, categorizing and disseminating the rating information for participating merchants comprises the following steps:

S401: prompting a user to enter rating for a merchant; the user has the choice of either receiving a prompt that automatically start an application program 211 on the user device 200 or receiving a prompt that requires the user to start an application program on the user device 200. If the user selects the option of receiving a prompt that starts an application program automatically, a new user interface on the displaying unit 210 will appear and the rating application display will be presented to the user in which case the user makes proper selections for rating as prompted. In the case where the user selects the option of receiving prompt but yet an application program does not automatically start, the user device will receive the prompt from platform 300 and a notification for the user will be displayed on the user device display. At that point the user has the choice of either starting the application program that displays the rating information on displaying unit 210 or the user ignore the prompt on displaying unit 210. The prompt will be displayed multiple times with certain time intervals. The number of times and intervals are adjustable by the user based on presetting the notification application within the user device 200. These settings are also stored in platform 300 for each user so that platform 300 knows which user should receive how many prompts at what intervals.

S402: The criteria for rating is displayed such that for each of the rating criteria there are at least two options, where the user can select one of the options. Each of the at least two options represents different degree of satisfaction of the user regarding to a merchant. These criteria are displayed based on the alerting scheme described in step S401.

S403: The user selects one of the options presented to the user. The selection is communicated to aggregating unit 220.

S404: All the selections are aggregated and a rating data is generated.

S405: Platform unit receives the rating data and stores it in database 320.

S406: The rating data stored in database 320 is processed by analyzing unit 330 to generate a rating result.

S407: The rating result is sent to user device 200 from platform 300. The user has the option to select if the rating result should be communicated and displayed on user device 200 automatically or the user should be alerted for it. If it is done automatically, when the rating result for a given merchant changes, the information is communicated to user device 200 from platform 300 via network 100. When the information reaches to displaying unit 210, an application program 211 in user device 200 is automatically initiated to perform operations that causes display unit 210 to display new rating result on user displaying unit 210. If the user is alerted based on user preference, an application program does not automatically start in user device 200 upon receiving a new rating data from platform 300. Instead, an alert is displayed on user device 200 indicating that rating result for a merchant changed. The user can start the application program 211 to display the rating result on user device 200 if the user wishes to do so. If the user does not wish to see the rating result at the moment the alert is received, the alert is repeated for a number of time and with certain number of intervals. The number of alerts and the interval time are both determined by the user.

Step S406 further comprises the following sub-steps:
calculating the average rating score of each criteria and generating the calculated result;
matching the calculated result of each criteria with one color according to a determined interval; and
labeling each criteria with corresponding color to generate the rating result.

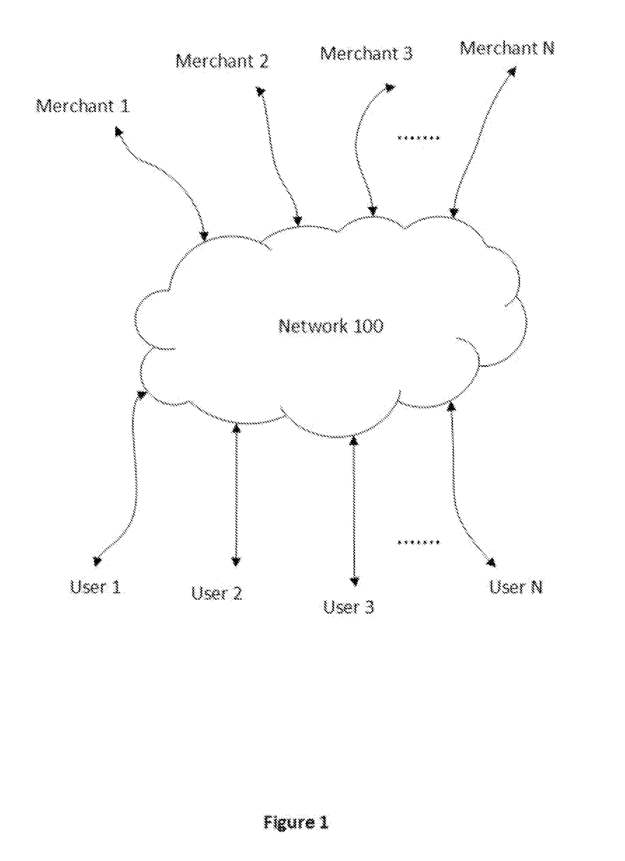

Referring to FIG. 1, FIG. 1 shows the communication between the user and the merchant. After the transaction with the merchant, users input data into device 200 to rate the merchant based on their experience during the transaction. Users are able to access the network 100 and retrieve information on multiple merchants. Users can understand the merchant via the rating system. Merchants connect to the user via network 100. Merchants are also capable of providing the rating data aggregated from the user to other user via network 100.

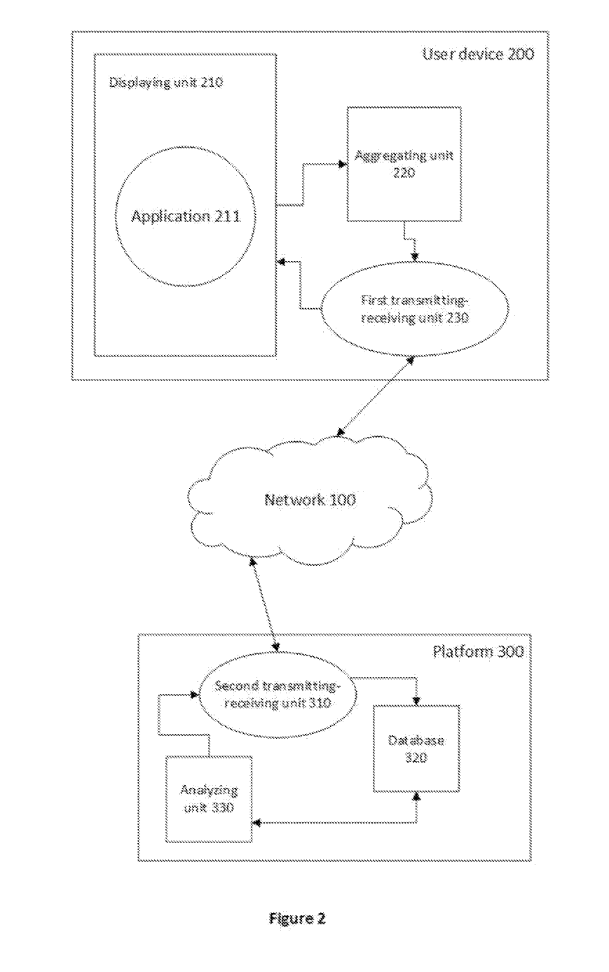

Referring to FIG. 2, while a user finished a transaction with the merchant, application program 211 will prompt the user to rate for the merchant who provided service for him/her. The user has the choice of either receiving a prompt that automatically start an application on the user device or receiving a prompt that requires the user to start an application program on the user device. If the user selects the option of receiving a prompt that starts an application program automatically, a new user interface on the user device screen will appear and the rating application display will be presented to the user in which case the user makes proper selections for rating as prompted. In the case where the user selects the option of receiving prompt but yet an application program does not automatically start, the user device will receive the prompt from platform 300 and a notification for the user will be displayed on the user device display. At that point the user has the choice of either starting the application program that displays the rating information on the user device display or the user ignore the prompt on the user device display. The prompt will be displayed multiple times with certain time intervals. The number of times and intervals are adjustable by the user based on presetting the notification application within the user device. These settings are also stored in platform 300 for each user so that platform 300 knows which user should receive how many prompts at what intervals.

The user can rate for the merchant in application program 211 which is located in user device 200. User device 200 can be personal computer (e.g., desktop or laptop), tablet computer, mobile device (e.g., personal digital assistant (PDA) or smart phone) or any other suitable device and may vary in size, shape, performance, functionality, and price. Displaying unit 210 will display the information of the merchant and the rating criteria, the rating criteria can be quality (Q), service (S) and delivery (D).

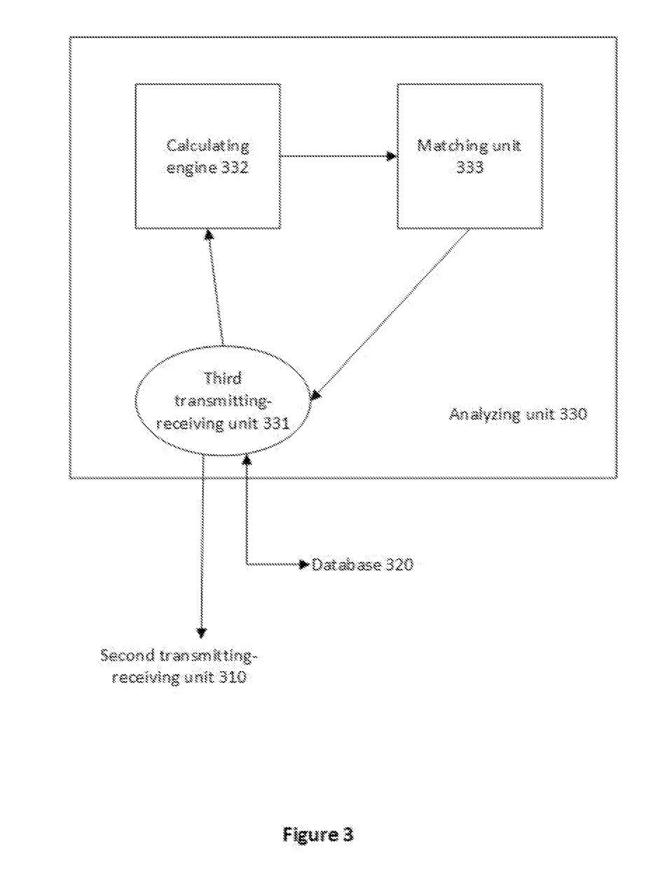

In one embodiment, each rating criteria has three options: not good, good/acceptable and very good. If a user selects “not good”, the merchant will get 1 scores for the corresponding rating criteria. If a user selects “good/acceptable”, the merchant will get 2 scores for the corresponding rating criteria. If a user selects “very good” for the corresponding rating criteria, the merchant will get 3 scores for the corresponding rating criteria. After the user made his/her choices or input in application program 211, aggregating unit 220 will aggregate the user's selection/input and generate a rating data. The rating data may include the date of this rating and the original scores. First transmitting-receiving unit 230 sends the rating data to network 100 to communicate with the platform 300. The platform comprises second transmitting-receiving unit 310, database 320, and analyzing unit 330. Referring to FIG. 3, the analyzing unit 330 further comprises third transmitting 331, calculating engine 332, and matching unit 333. Second transmitting-receiving unit 310 receives the rating data from first transmitting-receiving unit 230 via network 100, and then sends the rating data to database 320 to be stored. Analyzing unit 330 can crawl the rating data from database 320, and process the rating data. Especially, the rating data is crawled by third transmitting-receiving unit 331, the process of calculating is operated on calculating engine 332 and matching unit 333 matches the calculated results with different colors. Calculating engine 332 will calculate the average score of each criteria (Avg Q, Avg S, Avg D). The final average score of each criteria (Avg Q, Avg S, Avg D) is matched with one color according to a determined interval. Basically, Q (or S or D) is Green if the final average score is between Very Good and Good (closer to Very Good). Q (or S or D) is Orange if the final average score is between Good to Not good (closer to Good). Q (or S or D) is Red if the final average score is between Good and Not Good (closer to Not Good). Preferably, the interval of Red is in the range of 1 to 1.66, the interval of Orange is in the range of 1.67 to 2.33, and the interval of Green is in the range of 2.37 to 3. After processing, the criteria (Q, S, D) will be labeled with a corresponding color as a rating result. Analyzing unit 330 then sends the rating result to the network and first transmitting-receiving unit 230 crawls the rating result. First transmitting-receiving unit 230 then sends the rating result to application program 211, and application program 211 commands displaying unit 210 to display the rating result. At last, users can objectively understand this merchant without reading tons of subjective reviews. While a user accesses to network 100 via application program 211, the user can also choose a classification rule to get desired group of data. For example, the user can get the data “older than 15 days”, “newer than 15 days”, and check the rating result of “older than 15 days” or “newer than 15 days”. The rating data and the rating result is updatable in real time, which means the rating result displayed in display unit 210 is variable according to the aggregated selections.

The user has the option to select if the rating data should be communicated and displayed on user device 200 automatically or the user should be alerted for it. If it is done automatically, when the rating data for a given merchant changes, the information is communicated to user device 200 from platform 300 via network 100. When the information reaches to displaying unit 210, application program 211 in user device 200 is automatically initiated to perform operations that causes display unit 210 to display new rating data on user displaying unit 210. If the user is alerted based on user preference, an application program does not automatically start in user device 200 upon receiving a new rating result from platform 300. Instead, an alert is displayed on user device 200 indicating that rating result for a merchant changed. The user can start the application program 211 to display the rating result on user device 200 if the user wishes to do so. If the user does not wish to see the rating result at the moment the alert is received, the alert is repeated for a number of time and with certain number of intervals. The number of alerts and the interval time are both determined by the user.

In another embodiment, each rating criteria has two options. It maybe “quality+” and “quality−”, “service+” and “service−”, “delivery+” and “delivery−”. Here, “quality+” may means satisfied with the quality of the merchant, and “quality−” means unsatisfied with the quality of the merchant. Same to the “service+”, “service−”, and “delivery+”, “delivery−”. After the user made his/her choices or input in application program 211, aggregating unit 220 will aggregate the user's choice/input and generate a rating data. The rating data includes the date of this rating and the original scores. Then first transmitting-receiving unit 230 sends the rating data to network 100 to communicate with the platform 300. The platform comprises second transmitting-receiving unit 310, database 320, and analyzing unit 330. Referring to FIG. 3, the analyzing unit 330 further comprises third transmitting 331, calculating engine 332, and matching unit 333. Second transmitting-receiving unit 310 receives the rating data from first transmitting-receiving unit 230 via network 100, and then sends the rating data to database 320 to be stored. Analyzing unit 330 can crawl the rating data from database 320, and process the rating data. Especially, the rating data is crawled by third transmitting-receiving unit 331, the process of calculating is operated on calculating engine 332, and finally matching unit 333 matches the calculated result with different colors. Calculating engine 332 will calculate the rating data according to following formula:

$$Z = \frac{\frac{{\sum }_{i}^{n} {x}_{i} + 1.9208`}{{\sum }_{i}^{n} {x}_{i} + {\sum }_{i}^{n} {y}_{i}} - 1.96 * \frac{\sqrt{\frac{{\sum }_{i}^{n} {x}_{i} * {\sum }_{i}^{n} {y}_{i}}{{\sum }_{i}^{n} {x}_{i} + {\sum }_{i}^{n} {y}_{i}} + 0.9604}}{{\sum }_{i}^{n} {x}_{i} + {\sum }_{i}^{n} {y}_{i}}}{1 + \frac{3.8416}{{\sum }_{i}^{n} {x}_{i} + {\sum }_{i}^{n} {y}_{i}}}$$

Wherein:
   Z is the final scores of the rating criteria (Q or S or D);
   xᵢ=1,yᵢ=0, when a “quality+” (or “service+” or “delivery+”) option is selected by user i for the merchant;
   yᵢ=1,xᵢ=0, when a “quality−” (or “service−” or “delivery−”) option is the selected by user i for the merchant;
   Σᵢⁿxᵢ is the sum of the total number of “quality+” (or “service+” or “delivery+”) option;
   Σᵢⁿyᵢ is the sum of the total number of “quality−” (or “service−” or “delivery−”) option:

Calculating engine 332 calculates the final scores of each rating criteria, and then generates the calculated result. Matching unit 333 matches the calculated result of each criteria (Q, S, D) with one color according to an interval. Basically, Q (or S or D) is Green if the final average score is between Very Good and Good (closer to Very Good). Q (or S or D) is Orange if the final average core is between Good to Not good (closer to Good). Q (or S or D) is Red if the final average score is between Good and Not Good (closer to Not Good). Preferably, analyzing unit 330 will extract a Maxvalue and a Minvalue of the calculated result of each criteria from all the calculated result of the merchants connecting to network 100. Red color is defined as not good and its interval is in the range of Minvalue to ⅓Maxvalue. Orange color is defined as good/acceptable and its interval is in the range of ⅓Maxvalue to ⅔Maxvalue. Green color is defined as very good and its interval is in the range of ⅔Maxvalue to Maxvalue. Once the color is determined, matching unit 333 will label the criteria with the corresponding color to generate a rating result. Analyzing unit 330 sends the rating result to the network and first transmitting-receiving unit 230 crawls the rating result. First transmitting-receiving unit 230 sends the rating result to application 211, and then application 211 commands displaying unit 210 display the rating result. The user has the option to select if the rating data should be communicated and displayed on user device 200 automatically or the user should be alerted for it. If it is done automatically, when the rating data for a given merchant changes, the information is communicated to user device 200 from platform 300 via network 100. When the information reaches to displaying unit 210, an application program in user device 200 is automatically initiated to perform operations that causes display unit 210 to display new rating data on user displaying unit 210. If the user is alerted based on user preference, an application program does not automatically start in user device 200 upon receiving a new rating data from platform 300.

Instead, an alert is displayed on user device 200 indicating that rating data for a merchant changed. The user can start the application program to display the rating data on user device 200 if the user wishes to do so. If the user does not wish to see the rating data at the moment the alert is received, the alert is repeated for a number of time and with certain number of intervals. The number of alerts and the interval time are both determined by the user. Users can objectively understand this merchant without reading tons of subjective reviews. While a user accesses network 100 via application 211, the user can also choose a classification rule to get a desired group of data. For example, the user can get the data “older than 15 days”, “newer than 15 days”, and check the rating result of “older than 15 days” or “newer than 15 days”. The rating data and the rating result is updated in a real time, which means the rating result displayed in display unit 210 is variable according to the aggregated rating data.

Table I below provides rating data of three merchants (a, b, c) using the second embodiment. Actually, there can be many merchants connecting to platform 300.

TABLE 1

| Mer- | | | | | De- | Deliv- |
|---|---|---|---|---|---|---|
| chant | Quality+ | Quality− | Service+ | Service− | livery+ | ery− |
| a | 1 | 0 | 0 | 1 | 1 | 0 |
| a | 0 | 1 | 1 | 0 | 1 | 0 |
| a | 1 | 0 | 0 | 1 | 0 | 1 |
| a | 1 | 0 | 0 | 1 | 0 | 1 |
| a | 0 | 1 | 1 | 0 | 1 | 0 |
| b | 1 | 0 | 1 | 0 | 1 | 0 |
| b | 0 | 1 | 1 | 0 | 1 | 0 |
| b | 0 | 1 | 1 | 0 | 0 | 1 |
| b | 1 | 0 | 1 | 0 | 1 | 0 |
| b | 0 | 1 | 1 | 0 | 1 | 0 |
| c | 1 | 0 | 1 | 0 | 0 | 1 |
| c | 1 | 0 | 0 | 1 | 0 | 1 |
| c | 1 | 0 | 1 | 0 | 0 | 1 |
| c | 1 | 0 | 0 | 1 | 0 | 1 |
| c | 1 | 0 | 0 | 1 | 1 | 0 |

Users have to make a decision between the two options, which means that once the user selects “quality”, he/she cannot select “quality−” at the same time. That is the sentence “xᵢ=1,yᵢ=0, when a “quality+” (or “service+” or “delivery−”) option is selected by user i for the merchant; yᵢ=1,xᵢ=0, when a “quality−” (or “service−” or “delivery−”) option is the selected by user i for the merchant” in the formula.

Table II shows the sum of each criteria and its final scores of each criteria for three merchants.

TABLE II

| | sum of | Sum of | Sum of | Sum of | Sum of | Sum of | | | |
|---|---|---|---|---|---|---|---|---|---|
| Merchants | quality+ | quality− | service+ | service− | delivery+ | delivery− | Q | S | D |
| a | 3 | 2 | 2 | 3 | 3 | 2 | 0.46 | 0.12 | 0.46 |
| b | 2 | 3 | 5 | 0 | 4 | 1 | 0.12 | 0.57 | 0.38 |
| c | 5 | 0 | 2 | 3 | 1 | 4 | 0.57 | 0.12 | 0.04 |

In above Table II, the items of Q, S and D respectively correspond to the calculated result of the three criterias: quality, service, and delivery.

Table III shows the interval of the three grades based on the data in Table I and Table II.

TABLE III

| | | | | Start of | Start of |
|---|---|---|---|---|---|
| | MAX | MIN | Start of Red Interval | Orange Interval | Green interval |
| Q | 0.57 | 0.12 | 0.12 | 0.19 | 0.38 |
| S | 0.57 | 0.12 | 0.12 | 0.19 | 0.38 |
| D | 0.46 | 0.04 | 0.04 | 0.15 | 0.31 |

Red, Orange, Green are matched with the three grades of the criteria of quality, service, delivery.

While user device 200 displays the rating results, users can understand the Quality and Service and Delivery of the merchant by the color of QSD and the final scores. The colors are determined by the final scores and this provides the user with a visual understanding.

For example, when the user looks at a merchant with 50 reviews, and QSD (Q is green, S is Orange and D is Red). The user will know that overall: this merchant's delivery is not good, service is average/acceptable and quality is Very good. Therefore, the user will objectively understand this merchant without having to read tons of subjective reviews.

The present invention has been described with the preferred embodiments necessary for a successful patent application. It is foreseeable that a variety of modifications and changes may be made without departing from the scope of the patent for invention. Those changes or modifications will be defined in appended claims.

I claim:

1. A rating system, comprising:
a plurality of user devices,
a platform communicating with the plurality of user devices;
wherein each of the user device comprises:
a displaying unit;
an application program located on the displaying unit is configured to prompt users to rate a merchant after finishing a transaction with the merchant, and generate an input rating data;
an aggregating unit configured to aggregate the input rating data to generate a rating data; and
a first transmitting-receiving unit configured to transmit the rating data;
wherein the platform comprises:
a second transmitting-receiving unit configured to receive rating data transmitted by the plurality of user device,
an analyzing unit configured to process the rating data in order to obtain a plurality of calculated results and then match the calculated results with corresponding colors to generate a plurality of rating results, and
a database configured to store the rating data and the rating result with corresponding colors;
wherein the rating result with corresponding colors is configured to display in the displaying unit of the user device when the user device communicate with platform;

2. The rating system of claim 1, wherein rating criteria is selected from a group consisting of quality, service, delivery, value and environment.

3. The rating system of claim 2, wherein at least two rating criterias are selected.

4. The rating system of claim 3, wherein the rating result is classified into at least two grades, and each of the at least two grades is matched with one corresponding color.

5. The rating system of claim 4, wherein rating results is classified into three rating grade: a first grade, a second grade and a third grade.

6. The rating system of claim 4, wherein the first grade is matched with Red color which means the merchant is Not Good; the second grade is matched with Orange color which means the merchant is Good/Acceptable; and the third grade is matched with Green color which means the merchant is Very Good.

7. The rating system of claim 2, wherein the rating criteria are quality, service, delivery.

8. The rating system of claim 1, wherein the platform communicates with the user device via network.

9. The rating system of claim 1, wherein the user device is selected from a group of: personal computer, tablet computer, mobile device, or server, network storage device.

10. The rating system of claim 1, wherein the rating data and the rating result are updateable in real time, and the application is configured to push the updated rating result to the user device.

11. A method of collecting, storing, categorizing and disseminating the rating information for participating merchants, comprising:
prompting a user to enter rating for a merchant by an application located on a user device;
displaying at least one rating criteria for rating, each of the rating criteria has at least two options, wherein each of the options represents different degrees of satisfaction of the merchant;
selecting the options of each of the at least one rating criteria;
aggregating the chosen options and generating a rating data;
receiving the rating data and storing the rating data;
processing the stored rating data and generating a rating result;
displaying the rating result in the user device communicated with the platform.

12. The method of claim 11, the step of prompting a user to enter rating for a merchant further comprises sub-steps of:
determining to receive a prompt that automatically starts the application or receive the prompt that requires the user to start the application;
displaying a notification for the user on the user device if the user decides to receive the prompt that starts the application manually;
repeating to display the notification multiple times with certain time intervals if the user ignores the notification;
wherein the number of times and intervals are adjustable by the user based on presetting the notification within the user device.

13. The method of claim 11, wherein the step of displaying the rating result in the user device further comprises sub-steps of:
determining to displaying the available rating result automatically or receive an alert for the available rating result;
receiving the rating result from the platform if the user sets to displaying the available rating result automatically;
sending the alert to the user device to alert the user for the available rating result if the user sets to receive an alert for the rating result;
repeating to send the alert to the user device if the user ignores the previous alert;
receiving the rating result from the platform if the user selects to check the alert;
initiating the application;
displaying the rating result on the user device;

14. The method of claim 11, wherein the rating criteria is selected from a group consisting of quality, service, delivery, value and environment; wherein the rating result of each rating criteria comprises three rating grades comprising first grade, second grade and third grade.

15. The method of claim 14, wherein the step of matching the rating result with corresponding color comprises sub-steps of:
matching the first grade with first color which means the merchant is Not Good;
matching the second grade with second color which means the merchant is Good or Acceptable; and
matching the third grade with third color which means the merchant is Very Good.

16. The method of claim 14, wherein the first color is red, the second color is orange, and the third color is green.

17. The method of claim 15, wherein each option corresponds to a rating score.

18. The method of claim 17, wherein the step of processing the rating data and generating the rating result further comprises:
calculating the average rating score of each criteria and generating the calculated result;
matching calculated result of each criteria with one color according to a determined interval;
labeling each criteria with corresponding color to generate the rating result.

19. The method of claim 15, wherein at least two options are “+” and “−”.

20. The method of claim 19, wherein the step of processing the rating data and matching the rating result with corresponding color further comprises:
calculating the final score of each criteria and generating the calculated result;
matching the calculated result with one color according an interval;
labeling each criteria with corresponding color to generate the rating result;
wherein a formula for calculating the final score of each criteria is as follows:
$$Z = \frac{\frac{{\sum }_{i}^{n} {x}_{i} + 1.9208`}{{\sum }_{i}^{n} {x}_{i} + {\sum }_{i}^{n} {y}_{i}} - 1.96 * \frac{\sqrt{\frac{{\sum }_{i}^{n} {x}_{i} * {\sum }_{i}^{n} {y}_{i}}{{\sum }_{i}^{n} {x}_{i} + {\sum }_{i}^{n} {y}_{i}} + 0.9604}}{{\sum }_{i}^{n} {x}_{i} + {\sum }_{i}^{n} {y}_{i}}}{1 + \frac{3.8416}{{\sum }_{i}^{n} {x}_{i} + {\sum }_{i}^{n} {y}_{i}}}$$
wherein:
Z is the final score of the rating criteria;
xᵢ=1,yᵢ=0, when a “+” option is selected by user i;
yᵢ=1,xᵢ=0, when a “−” option is the selected by user i;
Σᵢⁿxᵢ is the total number of “+” option;
Σᵢⁿyᵢ is the total number of “−” option;
wherein the interval is determined by the following step:
extracting a Maxvalue and a Minvalue of the final score of each criteria from all the rating result of the merchants connecting to the platform;
defining a first color as the first grade and its interval is in the range from Minvalue to ⅓Maxvalue;
defining a second color as the second grade and its interval is in the range from ⅓Minvalue to ⅔Maxvalue;
defining a third color as the third grade and its interval is in the range from ⅔Maxvalue to Maxvalue.
